(19) United States
(12) Patent Application Publication
(10) Pub. No.: US 2018/0106235 A1
(43) Pub. Date: Apr. 19, 2018

(54) DAMP-PROOF LAYER FOR CREATING A SEAL FOR A POTENTIAL ENERGY STORE, AND METHOD FOR ASSEMBLING A SEAL FROM DAMP-PROOF LAYERS FOR A POTENTIAL ENERGY STORE

(71) Applicant: Heindl Energy GmbH, Stuttgart (DE)

(72) Inventor: Gerd Stenzel, Trossingen (DE)

(21) Appl. No.: 15/556,427

(22) PCT Filed: Mar. 1, 2016
(86) PCT No.: PCT/EP2016/054274

§ 371 Date: Dec. 14, 2017

(30) Foreign Application Priority Data
Mar. 13, 2015 (DE) 10 2015 103 760.2

(51) Int. Cl. F03B 13/06

(52) U.S. Cl. CPC F03B 13/06; F05B 2260/42; F05B 2240/57

(57) ABSTRACT

A damp-proof layer is provided for creating a seal for a potential energy store. The damp-proof layer has a supporting structure of wire ropes arranged next to one another or sections of one or more wire ropes arranged next to one another. At least parts of the plane in which the wire ropes lie, or at least parts of a plane running parallel thereto, form a fluid-tight surface or layer, in which the wire ropes, at the ends of the damp-proof layer, are each secured to an anchor piece for anchoring the damp-proof layer or are guided around the anchor piece. Between each two anchor pieces there is in each case arranged an elastic element. A seal is assembled from damp-proof layers on a potential energy store with a hydraulic cylinder, in which there is arranged a piston for storing energy in the form of potential energy of the piston.

### TECHNICAL FIELD

The system described herein relates to a seal for a potential energy store, and more particularly a damp-proof layer for a seal of a potential energy store, and a method of assembling a seal of a potential energy store from damp-proof layers.

### BACKGROUND OF THE INVENTION

The increased use of renewable energies, in particular the construction of numerous photovoltaic and wind power installations, the energy production of which is dependent on uncontrollable environmental conditions, has led to a situation in which, in phases in which these output their peak power, surplus energy is available and must even be sold at negative prices. On the other hand, for phases in which said installations cannot contribute to the energy supply, conventional power plants must be kept on standby. Accordingly, the development of energy stores, in particular energy stores which have a large storage capacity, has taken on increased importance.

One category of such energy stores is potential energy stores, in which excess energy is utilized to increase the potential energy of a (large) mass. In addition to pumped storage power plants which have been known for many years, in the case of which water is pumped into a reservoir at a higher level in order to store potential energy, potential energy stores are known, for example from DE 10 2010 034 757 B4. In such potential energy stores, a large mass is raised relative to the Earth's surface using a hydraulic fluid, for example water, in a hydraulic cylinder, by virtue of the hydraulic fluid being pumped via one or more lines, such that the mass practically constitutes the piston which is moved in the hydraulic cylinder, and energy is stored as potential energy of the raised piston. Here, the mass may be formed in particular by a cut-out rock, and the required hydraulic cylinder may be formed by the stone surrounding the cut-out rock.

The major advantage of this construction, in the case of which piston diameters and stroke heights of several hundred meters can be realized, lies in the very high storage capacity of the installations, which greatly exceeds that of conventional storage power plants.

It is naturally necessary in the case of such potential energy stores, which will hereinafter be referred to as generic potential energy stores, for a seal to be arranged between the large mass, for example the rock mass, and the hydraulic cylinder, for example the surrounding stone, in order to prevent the uncontrolled escape of the hydraulic fluid bypassing the line system. A series of proposals for the construction of such seals is disclosed for example in the German patent application with the application number DE 10 2014 102 405.2.

There is a need to find means and ways of installing the seals in the realization of generic potential energy stores, wherein, in light of the dimensions and specific demands on the generic potential energy store, it is necessary in particular for the seal to be assembled from individual components on site and directly at the potential energy store.

### SUMMARY OF THE INVENTION

Described herein is a seal membrane for producing the seal for a generic potential energy store, and a method for installing a seal composed of such seal membranes on a generic potential energy store.

Owing to the dimensions of a generic potential energy store, which may involve piston diameters and stroke heights of several 100 m, it is the case according to an embodiment of the system described herein that the seal is assembled for the first time during its installation from seal membranes, that is to say from substantially rectangular strips of a material or composite which comprises at least one component which has a sealing action with respect to the passage of a fluid.

In the description of the system provided herein, the greatest extent of the strips defines the length thereof, and the smaller extent direction defines the width thereof. The thickness of a strip is in turn very much smaller than the width thereof. The ends of the seal membrane are situated at the relatively short sides, which define the width, of the substantially rectangular strip. For example, the length of a membrane corresponds to approximately 55% of the maximum stroke height of the generic potential energy store for which the seal is envisaged; typical widths are 3 m, and typical thicknesses are 1 cm. In this disclosure, surfaces of the seal membrane refer to those surfaces which are delimited by the length sides and the width sides of the seal membrane, whereas the remaining surfaces form the edge of the seal membrane.

A seal membrane according to an embodiment of the system described herein for producing a seal for a potential energy store has a support structure composed of mutually adjacently arranged steel cables or mutually adjacently arranged sections of one or more steel cables, which preferably run substantially parallel to the direction which defines the length of the membrane.

It is explicitly pointed out at this juncture that “mutually adjacent” does not necessarily mean “mutually parallel” or “directly adjacent”, and, in practice, it is advantageous for the steel cables of the installed seal to run at least with a profile component in a radial direction with respect to the axis of the stroke direction, which has the effect that the spacing of the steel cables to one another is slightly smaller at that side of the seal which faces toward the piston than at the side facing toward the inner wall of the hydraulic cylinder. The practical relevance of said profile emerges from the fact that, overall, it is a circular-ring-shaped opening that is to be sealed off.

Furthermore, in the case of the seal membrane according to an embodiment of the system described herein, at least parts of the plane in which the steel cables lie or at least parts of a plane running parallel thereto form a fluid-tight face or fluid-tight layer, such that the sealing action is ensured at least in those sections of the seal membrane in which it is required. This may be realized, as will be discussed in more detail below, for example by means of the arrangement of a fluid-tight fabric on the support structure or by virtue of the support structure being embedded into a suitable polymer matrix, for example into rubber, which, in particular, can be applied in a liquid state during the production of the seal membrane and then solidifies.

In addition or alternatively to the provision of a solidified fluid-tight material layer, the steel cables may be connected to one another by means of a fabric, wherein, in the latter case, the fabric must be fluid-tight. This is possible for example by means of interweaving with a fabric strip or by areal connection to a fabric piece which is adapted to the size of the support structure. Here, the fabric should preferably be expandable at least by a factor which corresponds to the ratio of inner radius of the stroke cylinder to outer radius of the piston.

According to an embodiment of the system described herein, the steel cables are, at the ends of the seal membrane, in each case fastened to an anchor piece or led around an anchor piece. Said anchor pieces serve in particular for permitting secure anchoring of the seal membranes, or of the seal assembled from such seal membranes, in the wall of the piston and/or of the stroke cylinder.

Furthermore, according to an embodiment of the system described herein, in each case one elastic element is arranged between two anchor pieces. By means of this measure, it is achieved that the ends of the seal membrane or of the seal assembled therefrom can be arranged flush on curved surfaces with different radius of curvature, specifically the outer surface of the piston and the inner surface of the stroke cylinder. The elastic elements may for example be disks composed of rubber or of silicone. The thickness of said disks should slightly exceed the gap width, that is to say the spacing between two adjacent and/or substantially mutually parallel-running sections of the steel cable in the support structure.

To achieve this, it is desirable that the ends of the seal membrane be on the one hand capable of being shortened by compression and/or lengthened either by relaxation or by expansion, which may be made possible through the provision of the elastic elements between the anchor pieces. On the other hand, an adaptation of the originally planar seal membrane to the curvature of the surfaces on which the seal membrane or the seal assembled from the seal membranes must be anchored is desirable. This deformability also may be achieved by means of the elastic elements.

In a refinement of the system described herein, the anchor pieces and the elastic elements have in each case one opening through which a flexible bracing means is guided, such that the spacing between two anchor pieces can be reduced by compression of the elastic elements arranged therebetween and/or can be increased by expansion of the elastic elements arranged therebetween. The bracing means is thereby integrated directly into the seal membrane.

The anchor pieces are preferably formed as metal plates with a cable-guiding groove formed therein, the thickness of which, defined by the smallest spacing between two mutually opposite sides, lies between two times and five times the diameter of the steel cables that are used, and is preferably two times said diameter plus the gap width, that is to say the spacing between two adjacent sections of the steel cable in the support structure. Preferred materials for the anchor pieces are high-grade steel or aluminum.

The outer contour of the narrow side of the anchor pieces preferably has, in each case, corners, recesses or projections on the side facing toward the opposite end of the seal membrane, because this permits secure anchoring of the anchor pieces in the inner wall of the stroke cylinder or the outer wall of the piston. This can be easily realized if the outer contour of the anchor plate corresponds to the shape of a rectangle with a semicircle added thereto on the side averted from the opposite end of the seal membrane.

In order to be able to connect adjacent seal membranes to one another in a particularly effective manner, wherein said connection is required for producing the seal, it is the case in an embodiment of the system described herein that the seal membrane has, on one longitudinal side thereof, a first connecting section in which the fluid-tight layer and/or the fabric of one membrane surface is of relatively thin form and, on the other longitudinal side thereof, a second connecting section in which at least the fluid-tight layer and/or the fabric protrudes outward beyond the flexible support structure on said surface. Two adjacent seal membranes of such design can then be easily connected to one another by virtue of joint overlaps being produced between the first connecting section of the first seal membrane and the second connecting section of the second seal membrane or between the first connecting section of the second seal membrane and the second connecting section of the first seal membrane, and said connecting sections then in each case being adhesively bonded and/or welded to one another in a shear-resistant and compression-resistant manner. Here, a length of the connecting sections of approximately 5 to 10 cm has proven to be expedient.

In an embodiment of said refinement of the system described herein, in the first connecting section, fluid-tight layer and/or fabric are lessened to such an extent that the steel cables are at least partially exposed there, whereas, in the second connecting section, the protruding section of the fluid-tight layer and/or of the fabric has receptacles for said steel cables. In this way, particularly resilient connection is made possible which furthermore yields an exact alignment of the interconnected seal membranes.

It is additionally explicitly pointed out that, in the second connecting section, because it has no steel cables, it is the case generally and in an embodiment that in each case no anchor pieces are provided either.

In an embodiment of the system described herein, the fluid-tight face is formed at least inter alia (which means that said fluid-tight face may have not only the components mentioned below but also further components, that is to say need not be composed only of the components mentioned) in that the adjacent steel cables or sections of a steel cable are connected to one another at least on one side by means of a fabric, and/or in that the support structure is, at least in sections, at least on one side, either coated with a fluid-tight layer or impregnated with a solidified fluid-tight material. Rubber, silicone, natural rubber or an elastic plastic are particularly suitable as materials for forming said layer or for the impregnation of the support structure.

It should also be noted that, depending on the construction of the seal, the seal membrane need not imperatively impart a sealing action over its entire length, but rather may, or even must, in some cases, comprise seal sections which impart a sealing action and layers which are permeable to the fluid, as emerges for example from the German patent application with the application number DE 10 2014 102 405.2.

It is furthermore particularly preferable if the seal membrane has, on at least one side, in particular on the side facing toward the outer wall of the piston in an installed state and/or on the side facing toward the inner wall of the hydraulic cylinder in an installed state, an anti-adhesion layer which counteracts an adhesion of the seal membrane to the corresponding surface of the piston or of the hydraulic cylinder even under high contact pressure. In this way, even if the potential energy store remains stationary in a particular state of charge for a long period, in particular in a fully discharged and/or fully charged state, it is ensured that the seal is not damaged when the state of charge begins to change again, because the seal moves away from the surfaces easily owing to the anti-adhesion layer.

In an embodiment of the system described herein, a method is provided for installing a seal composed of seal membranes, for example, for installing a rolling diaphragm seal such as is disclosed in the German patent application with the filing number DE 10 2014 102 405.2, on a potential energy store. The potential energy store may have a hydraulic cylinder in which there is arranged a piston for the storage of energy in the form of potential energy of the piston, wherein the position of the piston relative to the Earth's surface is variable. The potential energy store also may have a pump by means of which a hydraulic fluid can be pumped via lines into the hydraulic cylinder, such that the piston is raised, and a generator for converting flow energy of hydraulic fluid which is displaced out of the hydraulic cylinder as the piston moves downward into electricity, wherein the seal is arranged between the hydraulic cylinder and the piston. This method may include the following:

a) providing seal membranes or groups of interconnected seal membranes,
b) providing a crane on the top side of the piston or on the upper edge of the stroke cylinder,
c) providing an upper anchor box,
d) providing a lower anchor box,
e) suspending the seal membranes or the interconnected groups of seal membranes from the crane,
f) positioning the seal membranes or the groups of interconnected seal membranes by means of the crane such that the freely hanging end of the seal membranes or of the seal is situated at the level of the upper anchor box,
g) connecting the seal membranes or the groups of interconnected seal membranes to one another such that a seal is formed,
h) clamping the freely hanging ends of the seal membranes or of the groups of interconnected seal membranes or of the seal in the upper anchor box,
i) moving the seal membranes or the groups of interconnected seal membranes or the seal further into the gap between piston and hydraulic cylinder by means of the crane such that that end of the seal membranes or of the groups of interconnected seal membranes or of the seal on which the crane engages is moved approximately to the level of the lower anchor box,
j) releasing the connection to the crane, and
k) clamping that end of the seal membranes or of the groups of interconnected seal membranes or of the seal which is situated at the level of the lower anchor box into the lower anchor box.

It must basically firstly be noted that the abovementioned steps do not imperatively have to be performed in the stated sequence. In particular, the sequence of the “provision steps” a) to d) is variable. It is basically also possible for the anchoring in the lower anchor box to be performed both before and after the anchoring in the upper anchor box, and the connection of seal membranes or groups of interconnected seal membranes may be performed while these are hanging from the crane, are suspended at one side or are suspended at both sides. The sequence in which the anchoring in the upper and lower anchor boxes is performed then also influences the specific configuration of the steps in which the crane with the seal membranes, the interconnected seal membranes or the seal is moved.

Where the alternatives of seal membranes, interconnected seal membranes and also, in some cases, seal are mentioned in the claims, this is for the following reason: that the width of the seal membranes is, at present, restricted to a few meters for manufacturing reasons. While it does not appear practicable at present to transport a complete seal to a potential energy store and install it there, such that a modular installation, in the case of which at least a number of seal membranes are connected to one another for the first time at the potential energy store, appears unavoidable, the handling of multiple seal membranes which have already been connected to one another does appear to be manageable and yields the advantage that the number of connections to be produced in situ can be reduced, and can be relocated into the more favorable working environment of the facilities for production of the seal membranes. Therefore, not only the expression “seal membrane” but also the expression “groups of interconnected seal membranes” is used. In other words, in the context of this disclosure, the term “seal membrane” refers not only to individual seal membranes but also to multiple interconnected groups of seal membranes, and may even be used for a seal assembled from such seal membranes.

In the course of the method, the modules from which the seal is assembled, that is to say the seal membranes or the groups of interconnected seal membranes, must be connected to one another. The seal is then formed. Even after the connection, however, it may be the case that sections of the interconnected seal membranes, in particular the anchor pieces thereof, are still movable relative to one another.

Depending on the time at which the connection is produced, it is the case that seal membranes, groups of interconnected seal membranes or the complete seal is/are worked with during the subsequent positioning steps with the aid of the crane, with which the anchoring by means of the anchor pieces provided on the seal membranes in the provided anchor boxes is made possible, and during the anchoring, such that these alternatives are all allowed for in the wording of the claims.

The upper anchor box refers to the anchor box which, at the time of installation of the seal, that is to say in the case of a discharged potential energy store, is further remote from the base of the stroke cylinder than the lower anchor box. In general, the geometry of the—in many cases substantially cylinder-symmetrical—potential energy store, and in particular the stroke axis thereof, also determines the meaning of the expressions “outward”, “inward”, “upward” and “downward” in the context of a potential energy store of said type. “Upward” corresponds to the direction in which the piston moves during the storage of energy in the potential energy store, and “downward” corresponds to the direction in which the piston moves during the extraction of energy from the potential energy store. “Outward” means radially away from the stroke axis, and “inward” means radially toward the stroke axis.

However, the execution of steps e) to k) in the stated sequence is associated with numerous advantages, and is therefore preferred. Since, in the case of a rolling diaphragm seal, the seal and thus also the seal membranes or groups of interconnected seal membranes have a length which slightly exceeds half of the stroke height, it is possible, by means of the positioning as per step f), to achieve that the smooth piston surface can serve as a basis or counterbearing during the connection of the seal membranes or of the groups of seal membranes to one another, which is furthermore performed in the upper region of the piston, which is more easily accessible and around which additional working space can be created more easily if required.

Furthermore, by virtue of the fact that the suspension on the upper anchor box is performed first, it is made possible for the anchor pieces to be in a substantially unloaded state when they are clamped into the upper anchor box, which facilitates the handling thereof. If the seal membrane clamped in the upper anchor box is then lowered further, it is, in the end state, held substantially by the connection between anchor pieces and upper anchor box, and the connection to the crane can be released, such that the clamping into the lower anchor box can also be performed at anchor pieces of the seal membrane while the anchor pieces are substantially unloaded.

This advantage however comes at the cost that the seal membrane, group of interconnected seal membranes or seal must, during the lowering in the gap between wall of the stroke cylinder and piston, be “turned inside out” once, such that its initially outwardly pointing side points inward in the fully installed state. If this is not practicable for geometrical reasons, a solution to this problem is for the connection to the crane to be realized not by means of clamps which engage on the anchor pieces but by holding means which are provided on the seal membranes, for example eyelets into which a crane hook can engage. The seal membranes are thereby lowered into the gap in a state in which the anchor pieces at both ends of the seal membrane hang freely downward, that is to say point in the direction of the base of the potential energy store. As soon as the region of the upper anchor box has been reached, the fastening of the anchor pieces can be performed there. After further lowering of the crane hook, the anchoring on the lower anchor box is then performed.

In an embodiment of the method, in step b), a crane is provided which has at least one winch for each seal membrane or for each group of interconnected seal membranes, wherein the winches are in particular movable independently of one another on a circular arc. This facilitates positioning of the seal membranes or of interconnected seal membranes relative to one another while the connection thereof is performed or prepared.

Furthermore, such mobility of the crane may also be utilized to the effect that the tools used to produce the connections only have to be provided at one point on the hydraulic cylinder, because the seam to be produced in each case can be moved to the location of the tool by rotation. This is expedient in particular if the gap between hydraulic cylinder and piston must be locally widened in order to permit the use of said tools.

It is particularly expedient if, in step c), the upper anchor box is provided, and, in step e), the lower anchor box is provided, by virtue of a groove or recesses being formed into the outer wall of the piston or into the inner wall of the hydraulic cylinder in encircling fashion, in which groove or recesses a profile, preferably a steel profile, is arranged which is locally adapted to the outer contour of the narrow side of the anchor pieces, and by virtue of a fixing means for fixing the anchor pieces in the anchor box being provided in the recess or on the profile, preferably steel profile.

A refinement of the system described herein provides that, in step e), the suspension on the crane is performed by means of a circular-arc-shaped installation traverse to which the seal membrane or the group of interconnected seal membranes are fastened. In this way, the seal membranes are already approximated to the shape in which they are clamped into the anchor boxes, which considerably facilitates this process. The radius defined by the circular arc of the installation traverse should in this case lie between the radius of the piston and the radius of the interior space of the hydraulic cylinder, and may for example be predefined by the mean value of said radii. In an embodiment of the system described herein, it is particularly preferred if the installation traverses are connectable to one another, specifically such that an overlap between the installation traverses is effected which corresponds to the desired overlap during the production of the connection between adjacent seal membranes or adjacent groups of interconnected seal membranes. This can considerably simplify the alignment thereof.

It is particularly preferable in an embodiment of the system described herein if, in step e), the suspension on the crane is performed using mechanically openable clamps which engage on anchor pieces of the seal membrane or of the group of interconnected seal membranes. This makes it easily possible for the anchor pieces to be released, by actuation of said mechanism, while they are arranged in the gap. For this purpose, it may be possible to use the same manipulators and/or lever arrangements as used for the clamping of the anchor pieces.

The clamping of the anchor pieces into the upper or lower anchor box may be considerably simplified if, before the clamping in steps h) and k), bracing means arranged in or on the seal membranes are used in order to adapt the width of that end of the seal membrane which is to be clamped in each case to the inner radius of the stroke cylinder and/or the outer radius of the piston, more specifically to the arc lengths predefined by the stated radii.

In a refinement of the method, it is provided that, before step k) is performed, the outer wall of the piston, and/or that side of the seal membrane, of the group of seal membranes or of the seal which faces toward said outer wall, is sprayed with a lubricant, which in particular reduces the adhesion between the outer wall of the piston and the material of which that side of the seal membrane, of the group of seal membranes or of the seal which faces toward the piston in the discharged state of the potential energy store, is composed.

Since, after the installation of the seal, the potential energy store is filled with the fluid with which it is to be operated, it is the case in the phase in which the piston does not yet begin to rise that a significant section of the seal is pressed against the outer wall of the piston until the pressure is sufficient to lift the piston. As a result of the prior application of a lubricant by spraying, the seal is prevented from adhering to the surface of the piston and then being damaged or even destroyed when the piston begins to move. In general, it may be expedient for lubricant to also be continuously or periodically replenished by spraying during the movement of the potential energy store during the operation thereof, in order to ensure as long as possible a service life of the seal. However, the risk of damage is at its greatest during the pressure build-up at the start of an operating phase, because, then, a change in length of the seal occurs which is not yet accompanied by a movement of the piston.

It has furthermore proven to be advantageous if, in the region below the lower anchor box, there is provided a multi-part toroidal hose, which is in particular assembled from circular-ring-shaped segments of overlapping hose pieces, or a single-part toroidal hose. The inner diameter of the hose from which the toroidal hose is formed should ideally correspond to the mean width of the gap between outer wall of the piston and inner wall of the stroke cylinder. Before or preferably after being provided, the toroidal hose, or the segments of a multi-part toroidal hose, is/are filled with a fluid with a density lower than the density of the fluid used for the operation of the potential energy store. Accordingly, the toroidal hose floats on the fluid used for operation, and is pressed by the buoyancy force against the respective upwardly curved “turnover point” of the seal, at which the latter changes its profile direction.

Such a toroidal hose which is adapted to the gap width acts as an effective auxiliary seal which, in the event of damage to the seal, counteracts an uncontrolled collapse of the piston back into the position which it assumes when the potential energy store is fully discharged. Leakages that occur at the turnover point itself are directly sealed off by said toroidal hose. Leakages that occur in one of the side sections of the seal which are in contact with the outer wall of the piston or with the inner wall of the cylinder likewise cannot lead to a rapid loss of fluid because, owing to the inner diameter of the toroidal hose which is adapted to the gap width, the shape of the turnover point is stabilized, and the liquid can at most escape through a narrow gap.

In an embodiment of the system described herein, a variant of the method is provided in which the radius of the piston is reduced in a section between the top side of the piston and the upper anchor box. This increases not only the structural space available for the installation of the seal membranes, groups of seal membranes or of the seal, and in particular for the connection of the seal membranes or groups of seal membranes to one another, but also provides easier access to the seal in the event of inspection and maintenance work.

If the steps h) to k) of the method are performed in the stated sequence, the required “turning inside out” of the seal membrane or of the arrangement of seal membranes or of the seal during step i) can be greatly facilitated if said seal membrane is in this case loaded with a ballast means. Here, the use of the hydraulic fluid, in particular of water, is particularly suitable.

### BRIEF DESCRIPTION OF THE DRAWINGS

The system described herein will be discussed in more detail below on the basis of figures, which show exemplary embodiments. In the figures:

FIG. 1 shows the schematic construction of a potential energy store according to an embodiment of the system described herein,

FIG. 2a is a schematic illustration of step e) of a method according to an embodiment of the system described herein,

FIG. 2b shows a clamp, which can be used in step e), in a first position,

FIG. 2c shows the clamp from FIG. 2b in a second position,

FIG. 2d shows an aspect of step f) of the method according to an embodiment of the system described herein,

FIG. 2e shows an aspect of step g) of the method according to an embodiment of the system described herein,

FIG. 2f shows an aspect of step h) of the method according to an embodiment of the system described herein,

FIG. 2g shows a snapshot during step i) of the method according to an embodiment of the system described herein,

FIG. 2h shows an aspect of step j) of the method according to an embodiment of the system described herein,

FIG. 3a shows a partial illustration of a plan view of an example of a crane to be provided as per step b),

FIG. 3b shows a second view of the crane from FIG. 3a with a suspended seal membrane,

FIG. 3c shows a third view of the crane from FIG. 3a with two suspended seal membranes,

FIG. 4a is a schematic illustration of a rolling diaphragm seal in the position which it assumes when the potential energy store is fully discharged when filled with hydraulic fluid,

FIG. 4b is a schematic illustration of the position of the seal arrangement from

FIG. 4a when the potential energy store is semi-charged,

FIG. 4c is a schematic illustration of the position of the seal arrangement from FIG. 4a when the potential energy store is fully charged,

FIG. 5a shows a view of the support structure of a seal membrane c,

FIG. 5b shows an enlarged view of a first particularly preferred form of a connecting section at an end of a seal membrane,

FIG. 5c is a schematic illustration of the production of a connection between a first connecting section of one seal membrane and a second connecting section of a further seal membrane, with connecting sections as per FIG. 5b,

FIG. 5d shows the construction of an end section of a seal membrane according to an embodiment of the system described herein,

FIG. 5e shows an anchor piece and an elastic element,

FIG. 5f shows an end disk with cable anchoring,

FIG. 5g shows an end disk without cable anchoring with elastic bearing,

FIG. 5h shows an enlarged view of a second form of a connecting section at an end of a seal membrane,

FIG. 5i is a schematic illustration of the production of a connection between a first connecting section of one seal membrane and a second connecting section of a further seal membrane, with connecting sections as per FIG. 5h,

FIG. 6a shows a first embodiment of an anchor box,

FIG. 6b shows a second embodiment of an anchor box,

FIG. 7a shows an enlarged cross-sectional view of the turnover point of the seal with an auxiliary seal,

FIG. 7b shows a diagrammatic sketch of an auxiliary seal of modular construction, sectioned in a circumferential direction,

FIG. 7c shows an installation frame for the auxiliary seal,

FIG. 8a shows an optional design of an end section of the seal before the gap has been fully filled with hydraulic fluid, and

FIG. 8b shows the end section of the seal from FIG. 8a when the gap has been fully filled with hydraulic fluid.

Where figures relate to the same embodiment of the system described herein, identical reference designations are used.

### DESCRIPTION OF VARIOUS EMBODIMENTS

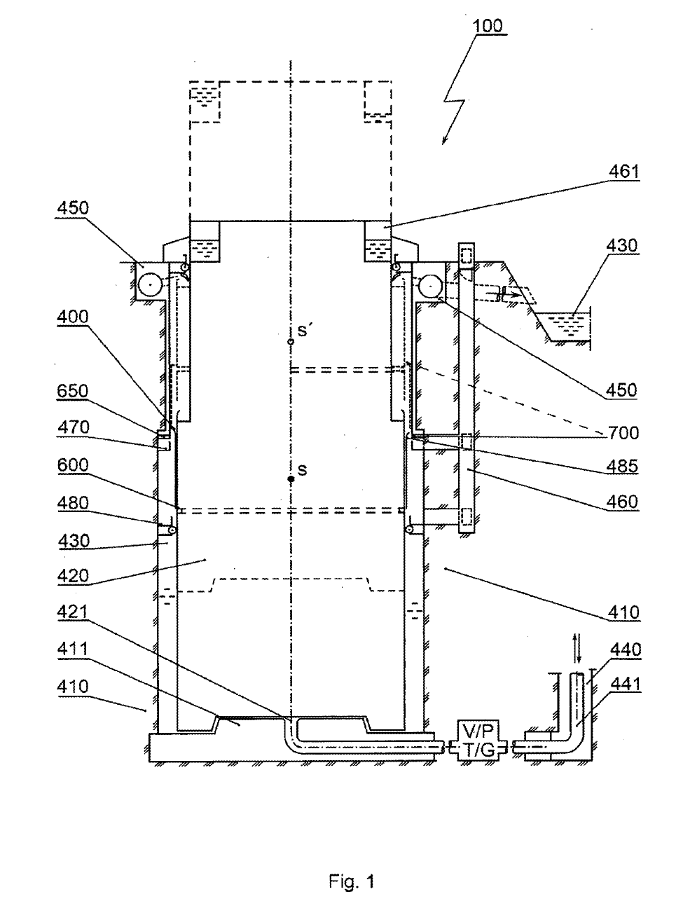

FIG. 1 is a schematic cross-sectional illustration of a first embodiment of a potential energy store 100 with hydraulic cylinder 410 and piston 420, with a seal 400 installed in anchor boxes 600, 650. A bearing block 411 is arranged on the base of the hydraulic cylinder 410. When the piston 420 has been lowered in the fully discharged state of the potential energy store 400 as illustrated in FIG. 1 by solid lines, the bearing block 411 engages into a corresponding opening 421 in the base of the piston 420.

By means of this correspondence, it is ensured that the piston 420 always remains in the same defined orientation in the hydraulic cylinder 410 and, if the bearing block is not rotationally symmetrical with respect to the longitudinal axis of the piston 420, a rotation of the piston 420 in the hydraulic cylinder 410 is prevented.

Also illustrated in sketched form in FIG. 1 is a transport, supply and turbine shaft 440, which runs parallel to the stroke direction of the piston 420 of the potential energy store 100, and a supply line 441 to the base of the hydraulic cylinder 410, through which the inflow and outflow of hydraulic fluid 430 in the interior space of the hydraulic cylinder 410 can take place. When hydraulic fluid 430 has been pumped out, and during the construction phase of the potential energy store 100, access to the interior space of the hydraulic cylinder 410 in the region of the base thereof is possible through the transport, supply and turbine shaft 440 and supply line 441.

Furthermore, in FIG. 1, a pump P, turbine T, generator G and valves V or sluices V, which are opened for a change in the state of charge of the potential energy store 100 and which otherwise remain closed in order to maintain a given fill level of hydraulic fluid 430, are illustrated as being arranged in the supply line 441, though each may also be arranged elsewhere. Likewise illustrated is a storage reservoir 431 for the hydraulic fluid 430.

In the case of the potential energy store 100 illustrated in FIG. 1, the upper edge of the hydraulic cylinder 410 is in the form of an encircling concrete ring 450.

It can likewise be seen in FIG. 1 that, in the upper region of the piston 420 of the potential energy store 100, there is arranged a tank 461 which is divided into segments which are not visible in the sectional illustration of FIG. 1 and which serves for the trimming of the hydraulic cylinder 410.

FIG. 1 also shows a lift shaft 460 which, proceeding from the top side of the hydraulic cylinder 410, leads into said hydraulic cylinder and provides access to upper and lower encircling galleries or grooves 470, 480 which are formed by a depression in the inner wall of the hydraulic cylinder 410 and which are preferably high enough to allow work to be performed standing up. They are situated slightly below the positions at which the seal 400 is clamped, for anchoring, into the anchor boxes 600, 650, and form a working platform from which said clamping can be performed.

A holder for support rollers is optionally provided below the lower gallery 480.

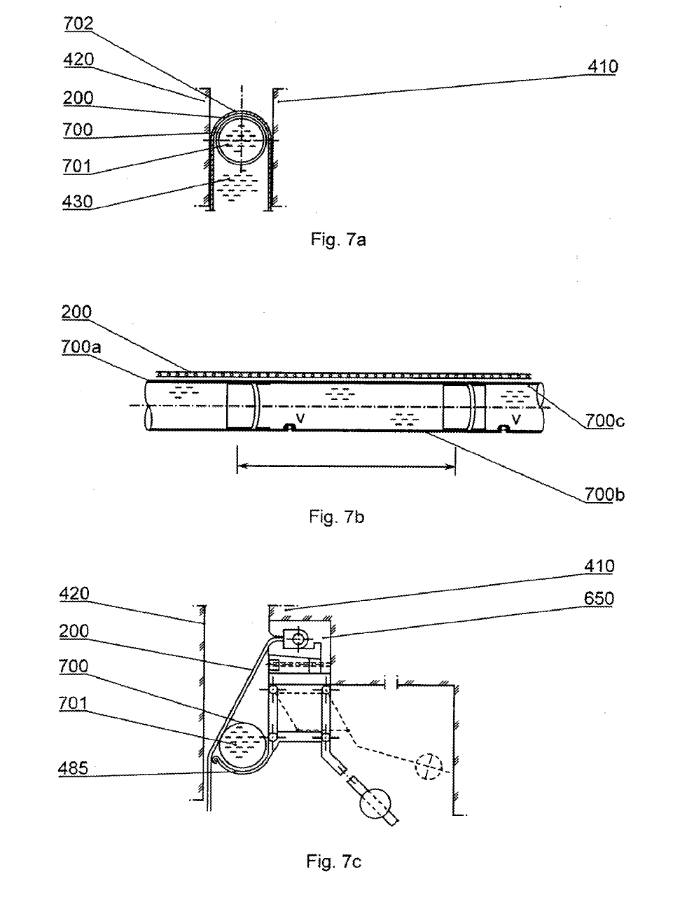

A toroidal hose 700, the construction of which will be described in more detail below on the basis of FIGS. 7a to 7c, is filled with a fluid 701 with a density lower than the density of the hydraulic fluid 430 with which the potential energy store 100 is operated, such that, during the operation of the potential energy store, said toroidal hose floats on the hydraulic fluid and is held against the turnover point 702 of the seal 400 by the buoyancy force, such that said toroidal hose functions as an auxiliary seal.

FIG. 1 also illustrates, by dashed lines, the position of the piston 420 when the potential energy store 100 is charged.

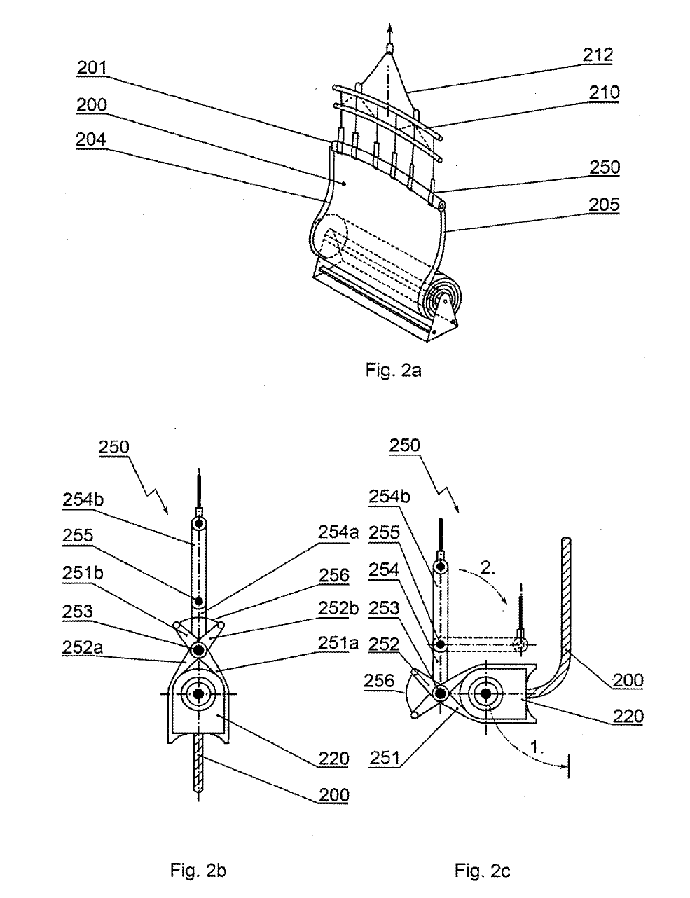

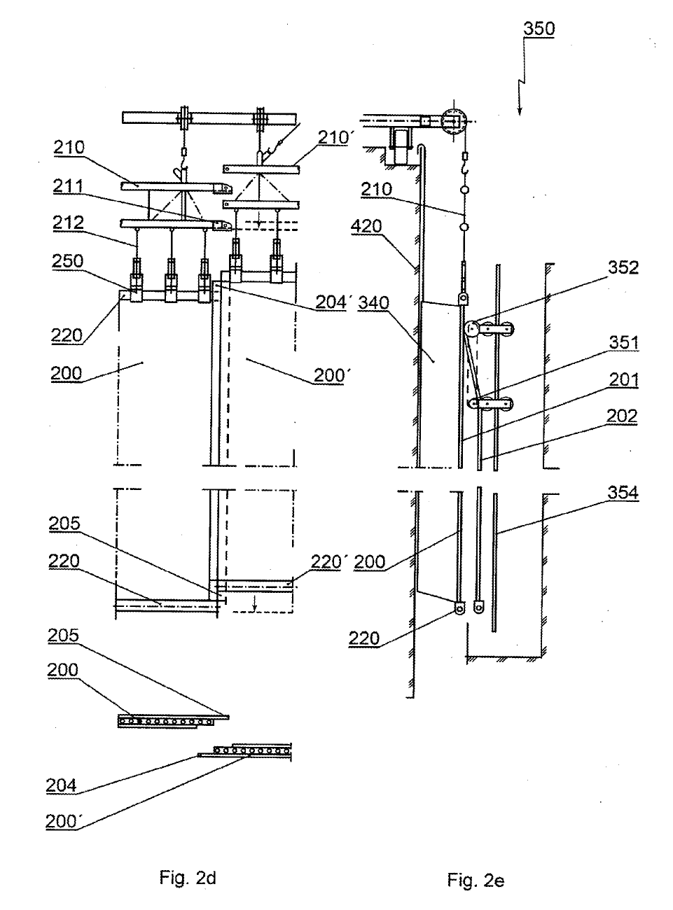

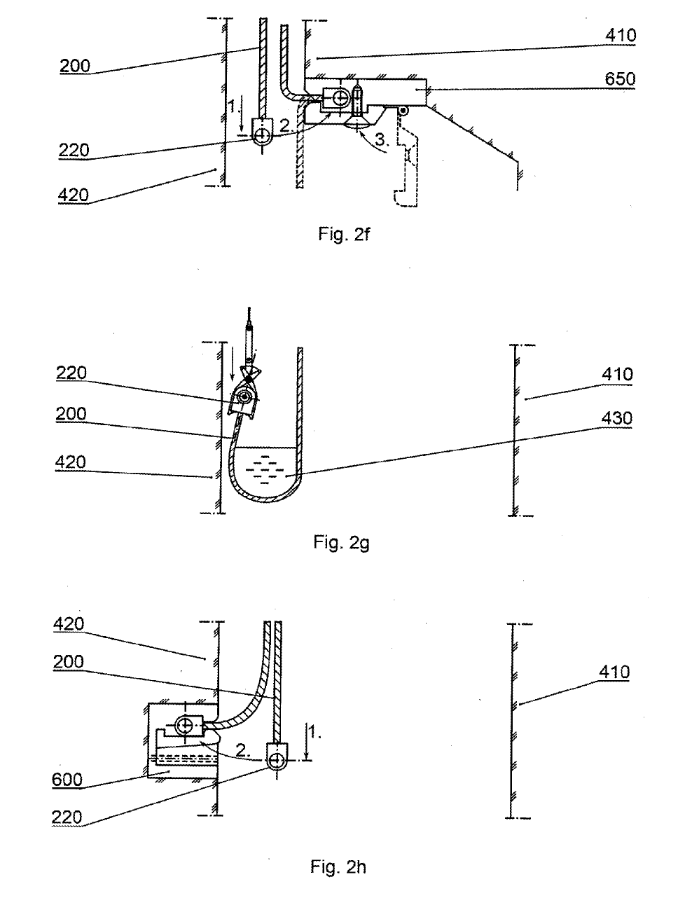

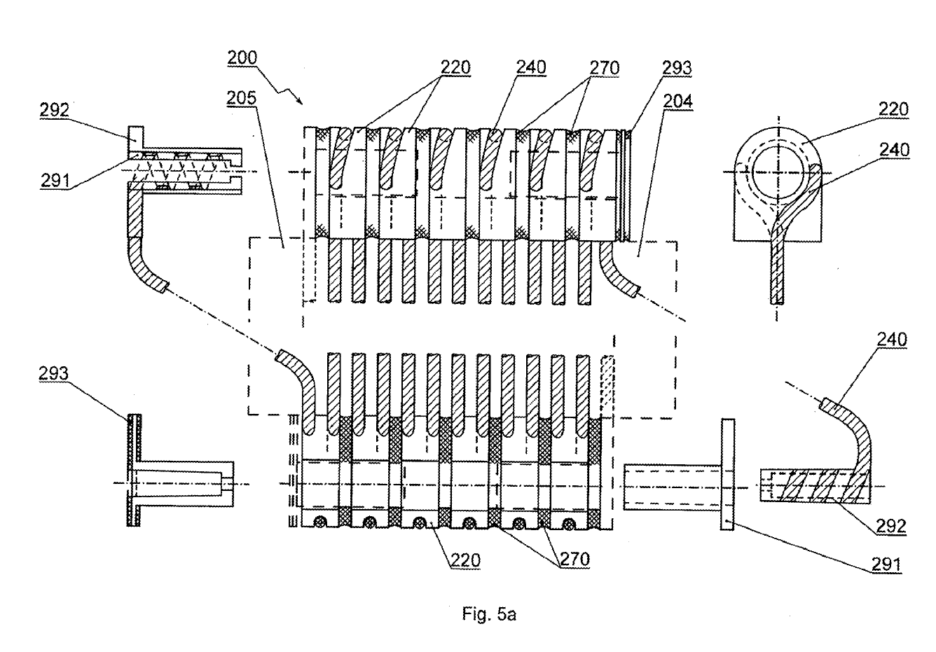

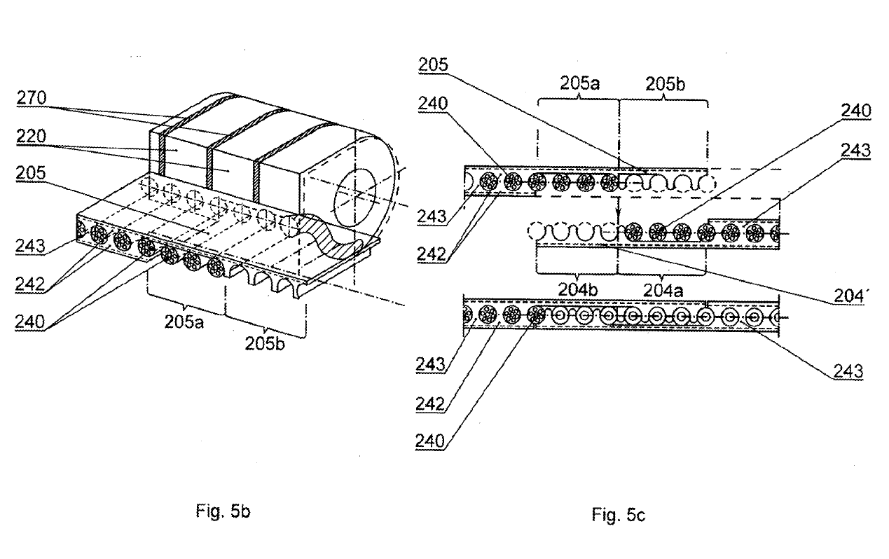

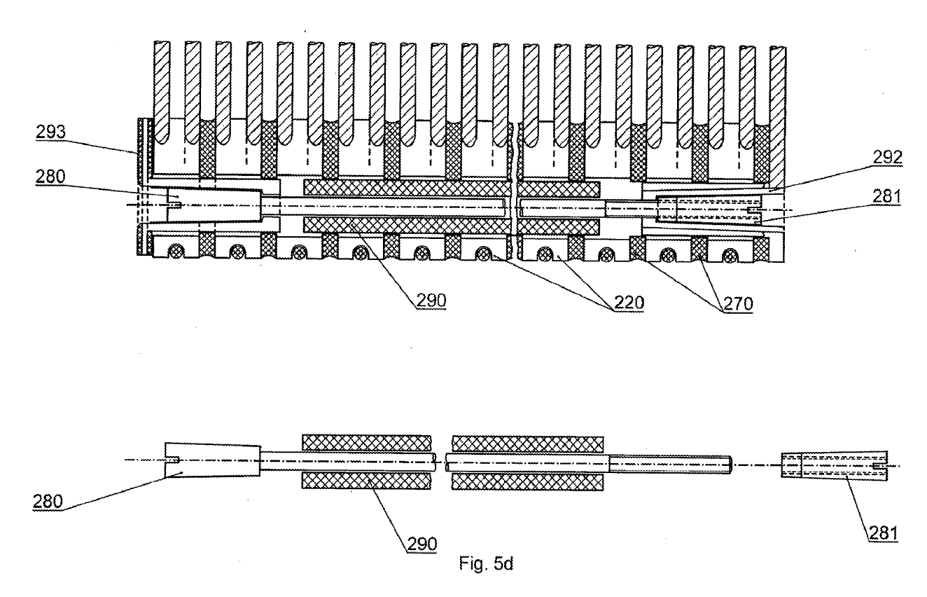

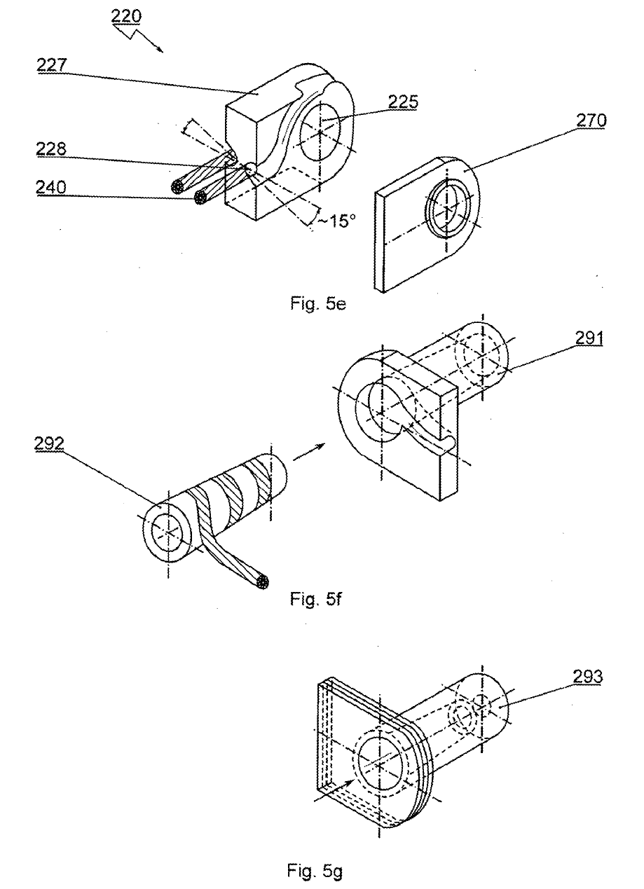

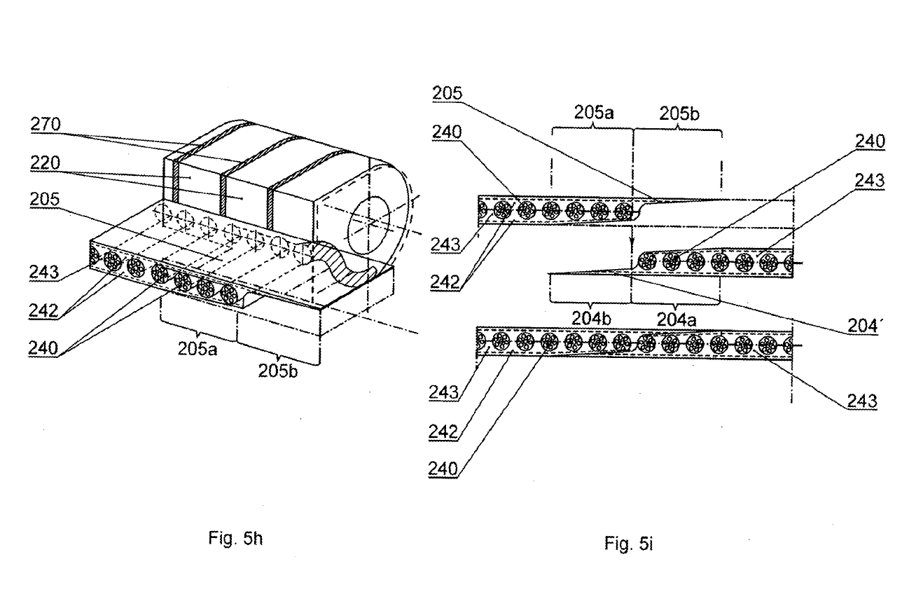

FIG. 2a is a schematic illustration of the suspension of a seal membrane 200, which in the present example is provided in rolled-up form, on a crane 300 (not illustrated in FIG. 2a), that is to say of step e) of the method according to the system described herein. Here, one end 201 of the seal membrane 200 is connected by means of clamps 250, the preferred construction of which is shown in FIGS. 2b and 2c, to a circular-arc-shaped traverse 210 which is raised by the crane 300 via a support harness 212. It is also possible to see, at the edges of the seal membrane 200, a first connecting section 204 and a second connecting section 205, which may be designed for example as illustrated in FIG. 5c. By means of said connecting sections 204, 205, it is possible for multiple seal membranes 200 to be joined together to form a group of interconnected seal membranes and finally to form the complete seal 400.

As shown in FIGS. 2b and 2c, the clamp 250 has a first limb 251 with a working section 251a and an actuation section 251b and has a second limb 252 with a working section 252a and an actuation section 252b, which limbs are connected to one another by means of a rotary spindle 253, the position of which defines the boundary between the working sections 251a, 252a and the actuation sections 251b, 252b. The working sections 251a, 252a are adapted in terms of their shape to the shape of the anchor pieces 220 so as to engage around said anchor pieces. Here, a compression spring 256 which acts between the actuation sections 251b, 252b presses the working sections 251a, 252a together.

A support bracket 254 is provided which is likewise arranged so as to be rotatable about the rotary spindle 253, on which support bracket the clamp 250 can be supported or fastened. Said support bracket 254 is distinguished by the fact that it has a first part 254a and a second part 254b, which is rotatable about a second rotary spindle 255 running parallel to the rotary spindle 253. In this way, it is made possible for the clamp 250 to hold the anchor pieces 220 in different orientations.

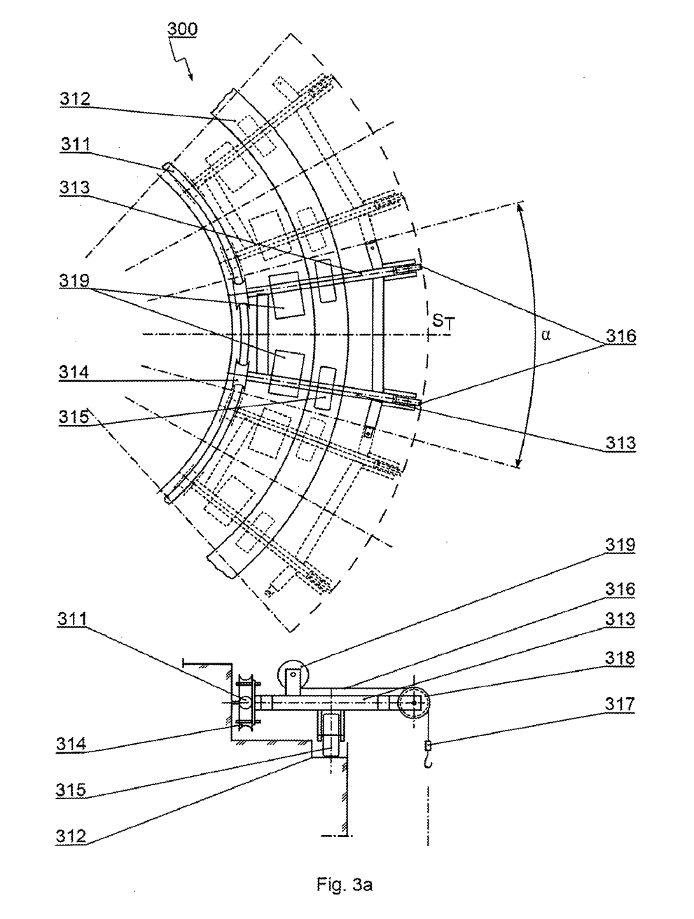

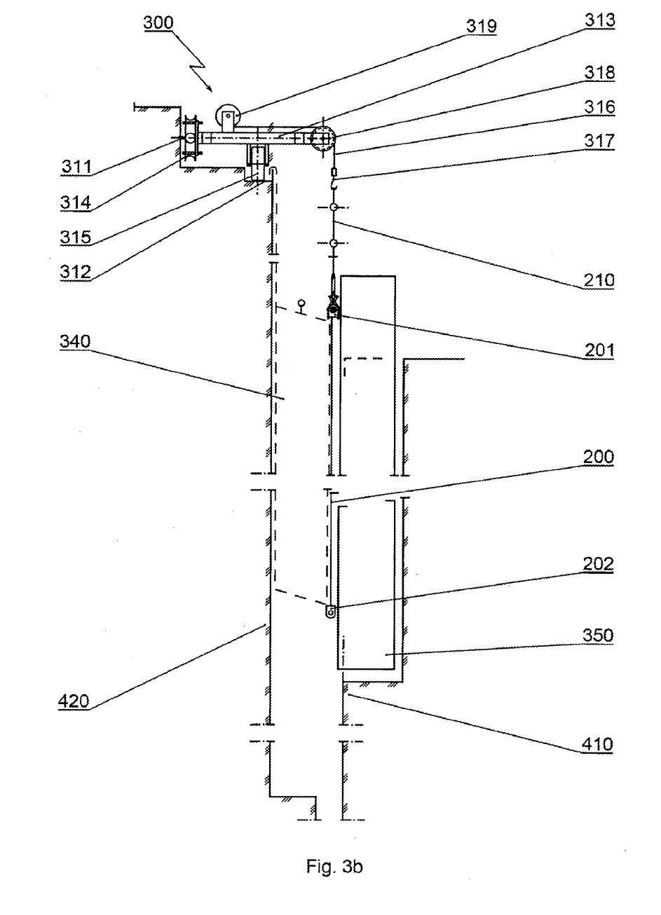

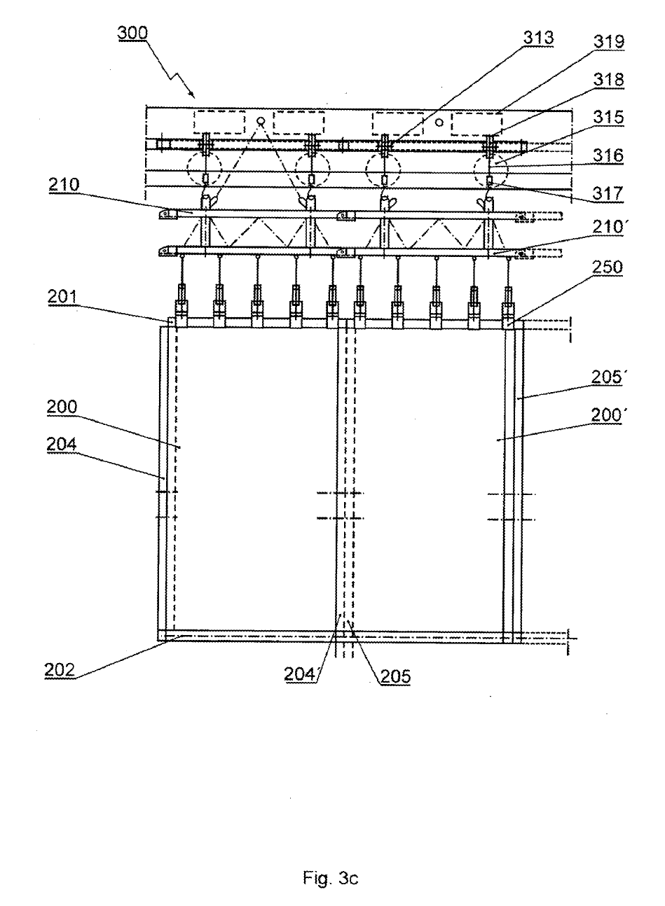

FIG. 2d shows an aspect of the positioning process as per step f) of the method according to the system described herein, specifically the positioning of two seal membranes 200, 200′ which are each fastened as described above by means of clamps 250, 250′ to traverses 210, 210′. To facilitate the positioning of the seal membranes 200, 200′, the traverses 210, 210′ have positioning sections 211, 211′ which can be connected so as to overlap one another, wherein the overlap is adapted to the overlap of the connecting sections 205, 204′ of the seal membranes 200, 200′, which is illustrated once again from a different perspective in the lower part of FIG. 2d. The seal membranes 200, 200′ thus positioned relative to one another can then be lowered into the gap between hydraulic cylinder 410 and piston 420 until the second end, at which the traverses 210, 210′ are not arranged, is approximately at the level of the upper anchor box. The situation after the positioning of the seal membranes 200, 200′ relative to one another before the lowering is also shown once again in FIG. 3b.

FIG. 2e schematically shows one possibility for realizing the connection of seal membranes 200, 200′ to one another. At at least one location in the edge region of the hydraulic cylinder 410, there is provided a gluing carriage 350 which runs along a guide rail 354. By means of a first roller 351, the gluing carriage 350 opens and applies glue to the joints between connecting sections 205, 204′, in order for these to then be glued under the pressure of a second roller 352. Alternatively, the connecting sections 205, 204′ may also be welded. The position in which this process preferably occurs is also illustrated once again in FIG. 3c, in which it can be seen particularly clearly that, in said position, a smooth surface of the piston 420, on which a gluing bed 340 is arranged if the radius of the piston 420 is reduced in its upper region, can serve as a basis for the connection process.

After the gluing of a joint, it is then possible for the crane 300 to be moved further on the circular rail system 310 which supports it, in order to transport the next joint to be glued to the gluing carriage 350.

As illustrated in FIG. 2f, the seal 400 that has been joined together from the seal membranes 200 now hangs, approximately at the level of the upper anchor box 650, in the gap between piston 420 and hydraulic cylinder 410. Now, the anchor pieces 220 are clamped into the anchor box 650, wherein, preferably, the circumference of the seal is adapted to the inner circumference of the hydraulic cylinder 410 beforehand by actuation of the bracing means of the seal membranes 200. This may be performed from the upper gallery or from the upper groove 470, wherein suitable tools, for example a lever system which is supported on a railing of the upper gallery and on the wall of the piston 420, may be used. As a result of this process, the seal 400 now hangs by one end on the crane hook 317 of the crane 300 and is anchored by the other end on the upper anchor box 650.

Next, the seal 400 must be turned inside out. For this purpose, that end of the seal 400 which is hanging on the crane hook 317 of the crane 300 is lowered further. FIG. 2g shows a snapshot during this process, which corresponds to step i) of the method according to the system described herein. To ensure that the process of turning inside out is performed in the narrow gap, ballasting with hydraulic fluid 430 as a ballast may be performed in the region of the bend of the seal.

Finally, the seal 400 must be unsuspended and anchored in the lower anchor box 600, as is schematically illustrated in FIG. 2h. The unsuspension may be performed by virtue of the actuation sections 251b, 252b of the clamp 250 being actuated from the lower gallery 480 with the aid of suitable tools, for example a lever system arranged on the outer wall of the piston 120. Subsequently, the anchor piece 220 is clamped into the lower anchor box 600 by means of suitable tools, wherein, for example, the lever system may also be used for this purpose.

FIG. 3a shows a partial illustration of the plan view of an example of a crane 300 to be provided as per step b), which crane is arranged on the piston 420. The crane 300 has a circular rail system 310 with an inner rail 311 and an outer rail 312. On the rail system there are guided multiple jibs 313 which, as can be seen in FIGS. 3b and 3c, are movable independently of one another by means of driven rollers 314, 315. Each jib 313 bears a winch 319 by means of which a load-bearing cable 316 can be wound up and unwound. On the load-bearing cable 316 there is arranged in each case one of the crane hooks 317, by means of which a diverting roller 318 can be raised and lowered.

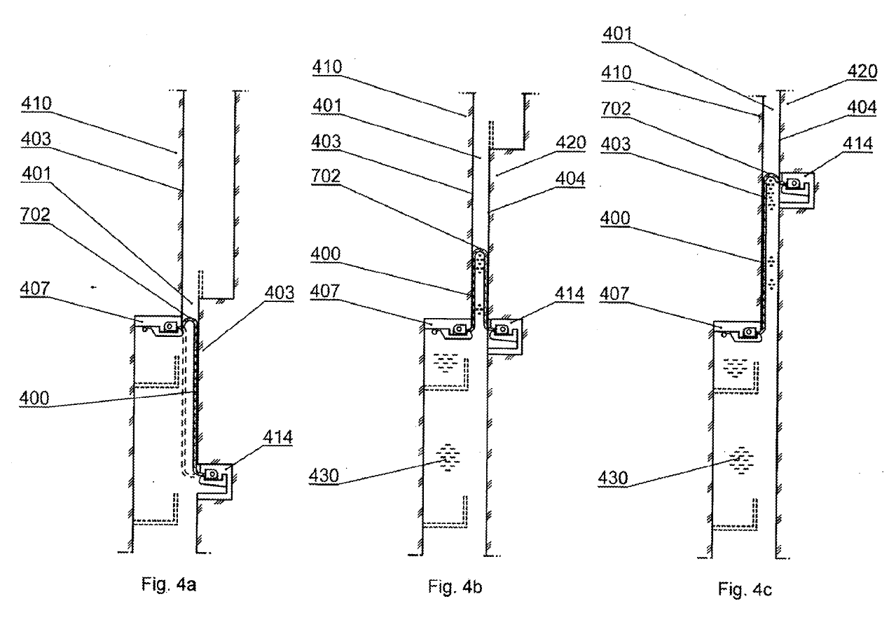

FIG. 4a shows, in cross section, a seal arrangement composed of a seal 400 which is designed as a rolling diaphragm. In the case of the seal 400, which seals off a gap 401 of gap width b between inner wall 403 of the hydraulic cylinder 410 and the outer wall 404, facing toward said inner wall, of the piston 420, the sealing section is formed by the entire seal 400. In other words, the seal 400 is, over its entire length, wherein the length is defined by the maximum spacing of the ends of the seal 400, sealed off against the passage of hydraulic fluid 430 by means of a fluid-tight layer applied to the support structure, which is formed for example by steel cables. The length of the seal 400 should exceed half of the maximum stroke height h of the potential energy store, specifically preferably by a few percent. For example, a length of the seal of 0.52*h may be used. This excess length is required not only to be able to compensate a possible transverse offset of the piston 420 in the hydraulic cylinder resulting from wind pressure but also, as discussed below, permits an adaptation of the shape of the seal 400 to the prevailing pressure of the hydraulic fluid, which is advantageous for the definition of the direction of the acting forces.

The seal 400 is clamped with one end in the anchor box 407, which, since the installation of the seal 400 is performed when the potential energy store is completely discharged, corresponds to the upper anchor box 650. The other end of the seal 400 is clamped in the anchor box 414, which corresponds to the lower anchor box 600.

FIGS. 4a to 4c schematically show the position of the seal 400 in the case of different stroke heights of the piston 420 relative to the hydraulic cylinder 410, which corresponds to different states of charge of the potential energy store, on the basis of a detail from a cross-sectional illustration of the potential energy store, which shows an inner wall 403 of the hydraulic cylinder, the gap b, and the outer wall 404 of the piston 420.

When the piston 420 has been fully lowered, as illustrated in FIG. 4a, the seal 400 is pressed almost entirely against the outer wall 404 of the piston 420 by the pressure of the hydraulic fluid 430. Since the length of the seal 400 is greater than the spacing between the two anchor boxes 407, 414, a section of the seal 400 is raised a short distance beyond the higher of the anchor boxes 407, and then led back to the anchor box 414 in an arc, owing to the pressure of the hydraulic fluid 430. Said arc, which corresponds to the region at which the seal 400 changes its profile direction from upward to downward, also defines the turnover point 702, discussed in more detail below, of the rolling diaphragm seal.

When the piston 420 has been raised halfway, as illustrated in FIG. 4b, the two anchor boxes 407, 414 are situated at the same height, such that the seal 400 is almost entirely freely movable and is thus pressed by the pressure of the hydraulic fluid 430 against the inner wall 403 of the hydraulic cylinder and against the outer wall 404 of the piston 405, wherein said sections transition into one another via an arcuate connection.

When the piston 420 has been fully raised, as illustrated in FIG. 4c, the seal 400 is pressed almost entirely against the inner wall 403 of the hydraulic cylinder 410 by the pressure of the hydraulic fluid 430. Since the length of the seal 400 is greater than the spacing between the two anchor boxes 407, 414, a section of the seal 400 is raised a short distance beyond the higher of the anchor boxes 414, and then led back to the higher anchor box 414 in an arc, owing to the pressure of the hydraulic fluid 430.

Viewing FIGS. 4a to 4c, it is in particular clear that the acting forces act primarily parallel to the stroke direction and are dependent on the gap width b. At the same time, it is clear that, with this seal structure, a change in the gap width b of the gap 401, such as may arise for example as a result of wind pressure, can be managed without problems.

FIG. 5a shows, in a partial exploded illustration, a view of the support structure of a seal membrane 200 according to the system described herein, which is delimited at both ends 201, 202 in its longitudinal direction by rows of anchor pieces 220, between which elastic elements 270 are arranged in each case. The length of the seal membrane 200 thus corresponds to the spacing between two mutually oppositely situated anchor pieces 220 arranged at different ends 201, 202 of the seal membrane 200. The transverse direction thereof, in which the width of the seal membrane 200 is defined, is accordingly the direction perpendicular to the longitudinal direction, in which anchor pieces 220 situated at the same end 201, 202 of the seal membrane 200 are arranged adjacent to one another. The thickness of the seal membrane is to be measured in the direction perpendicular to the longitudinal and transverse directions. Surfaces of the seal membrane 200 refer to the faces defined by the longitudinal and transverse sides.

As can be seen, a steel cable 240 is, in cable-guiding grooves 228 of the anchor pieces 220, looped around said anchor pieces and thus forms the support structure of the seal membrane 200. In order that the seal membrane 200 can impart a sealing action, a fluid-tight face (surface) or fluid-tight layer 243 must be provided which prevents the passage of the fluid through the support structure. Said fluid-tight surface or layer may be produced in different ways on or at the support structure. For example, the individual sections, running substantially parallel to one another, of the steel cable 240 may be connected to a fluid-tight fabric 242, for example may have such a fabric glued over them. Alternatively or in addition, the fluid-tight face may also be produced by virtue of the support structure being covered or impregnated with a liquid material, which thereafter solidifies and forms the fluid-tight face 241 or layer. Here, as materials, use may be made for example of natural rubber, rubber or plastics.

A specific example of a possible construction of the seal membrane 200 is shown in the detail illustration of FIG. 5b. The sections of the steel cable 240 are embedded into a fluid-tight layer 243, which is composed of rubber, and have had fabric 242 glued onto them on both sides. In this illustration, it can also be seen that the seal membrane 200 has, on one longitudinal side thereof, a connecting section 205 in which fabric and/or fluid-tight layer are of relatively thin form. Specifically, a first subsection 205a is provided, in which the embedding of the sections of the steel cable 240 into the fluid-tight layer 243 and the fabric 242 are omitted on one side, and a second subsection 205b is provided, in which the fabric 242 is omitted and no support structure is provided on one side, while in said section, however, the fluid-tight layer 243 is formed with recesses for accommodating sections of a steel cable 240, such that, in the subsection 205b, at least the fluid-tight layer and/or the fabric protrudes outward beyond the flexible support structure on the side of one surface.

FIG. 5c is a schematic illustration of the production of a connection between a first connecting section 205 of a seal membrane 200 and a second connecting section 204′ of a further seal membrane 200′, wherein the connecting sections 205, 204′ have each been constructed as described on the basis of FIG. 5b, but differ with regard to the surface at which the fabric 242 and the fluid-tight layer 243 composed of rubber have been omitted. Accordingly, it is possible for the first connecting section 205 and the second connecting section 204′ to be arranged in overlapping fashion, to be placed in overlap with one another, and to be adhesively bonded.

An alternative solution in relation to FIGS. 5b and 5c is shown in FIGS. 5h and 5i. The difference consists in the construction of the connecting sections. In the first subsection 205a, the embedding of the sections of the steel cable 240 into the fluid-tight layer 243 is progressively lessened toward the outside, and the fabric 242 is not provided on one side. In the second subsection 205b, on one side, the fabric 242 is omitted and a support structure is no longer provided, such that, in the subsection 205b, at least the fluid-tight layer and/or the fabric protrudes outward beyond the flexible support structure on the side of one surface. FIG. 5i shows how connecting sections of such construction of adjacent seal membranes are joined together.

FIG. 5d shows the construction of an end section of a seal membrane 200 according to the system described herein. It is possible to see a sequence of anchor pieces 220, between which elastic elements 270 are arranged in each case, wherein anchor pieces 220 and elastic elements 270 each have central openings 225, 275, through which a bracing bolt 280 with bracing nut 281 is pushed. The central section of the bracing bolt 280 is guided in a rubber tube 290, which has the effect that the bracing means is flexible enough to permit a curvature of the anchor bar formed by anchor pieces 200 and elastic elements 270. By tightening or loosening the bracing bolt 280, it is then possible in the case of this arrangement for the spacings between adjacent anchor pieces 220 and thus the length of the anchor bar as a whole to be influenced. Here, the transmission of pressure is realized in particular by the end disk 291 with cable anchoring 292, as shown in FIG. 5f, and the end disks 293 without cable anchoring, as shown in FIG. 5g.

FIG. 5e shows a single anchor piece 220 with narrow side 227, cable-guiding groove 228 and central opening 225.

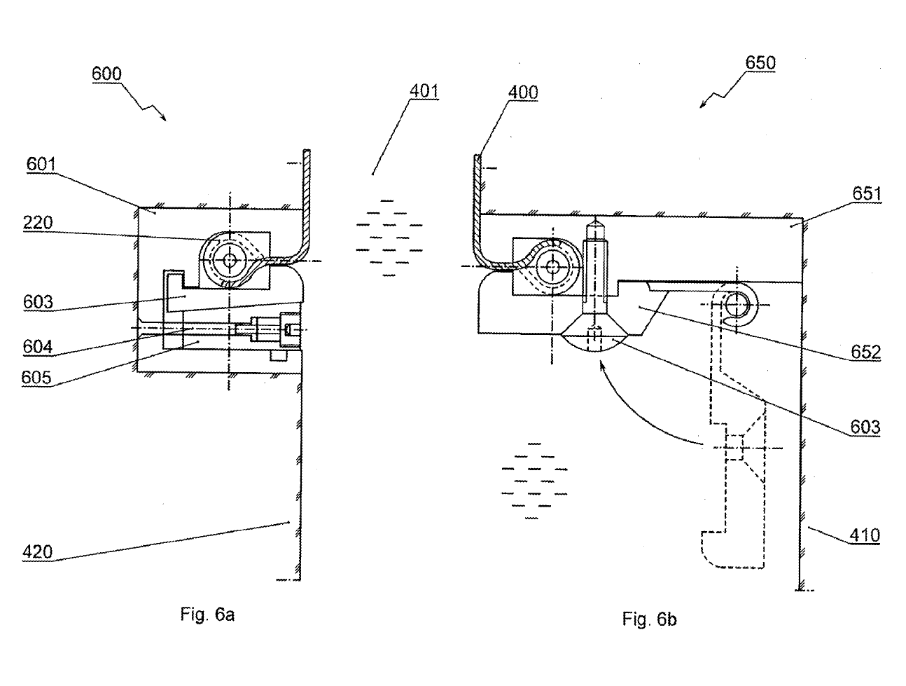

FIG. 6a shows a first embodiment of an anchor box, specifically of the lower anchor box 600 arranged on the piston, which is arranged in a groove 425 in the piston 420 opposite the lower gallery or the lower groove 480 provided in the hydraulic cylinder 410. A profile, preferably a steel profile 601, has been molded into the groove 480, the downwardly directed upper surface of which steel profile has been adapted to the outer contour of the narrow side of the anchor piece 220. After the anchor piece 220 has been inserted, an anchor clamp 603 is mounted onto the still-unguided sections of the outer contour of the narrow side of the anchor piece 220 and is braced by means of a bracing bolt 604 with wedge 605.

FIG. 6b shows a second embodiment of an anchor box, specifically the upper anchor box 650 arranged in the inner wall of the hydraulic cylinder 410. Said anchor box is arranged on the top side of the upper gallery or of the upper groove 470 and has a profile inserted onto said top side, preferably a steel profile, 651, the downwardly directed surface of which has been adapted to the outer contour of the narrow side of the anchor piece 220. After the anchor piece 220 has been inserted, a closure element 652 arranged pivotably thereon is pivoted closed, such that its contact face adapted to the still-unguided sections of the outer contour of the narrow side of the anchor piece 220 is placed in contact with the anchor piece. The bracing is then realized by a bolted connection by means of the bracing bolt 653.

FIG. 7a shows an enlarged cross-sectional view of the turnover point 702 of the seal 400 in an optional arrangement with an auxiliary seal in the form of a toroidal hose 700, which is filled with a fluid 701 which has a lower density than the hydraulic fluid 430. Accordingly, the auxiliary seal formed by the toroidal hose 700 floats on the hydraulic fluid 430 and is pressed against the turnover point 702 by the resultant buoyancy forces. Here, the purpose of the auxiliary seal consists in particular in preventing an uncontrolled “collapse” of the piston 420 in the event of a leakage in the seal 400. The leakage has a critical effect if it is present at the turnover point 702, because it is there—by contrast to other locations, at which the seal 400 is pressed against the wall of the piston 420 or of the hydraulic cylinder—that a free escape of the hydraulic fluid is possible if the auxiliary seal is not present. The toroidal hose 700 which floats on the hydraulic fluid 430 and which is pressed against the turnover point 702 by the buoyancy blocks the direct escape of the hydraulic fluid 430 and thus the excessively fast discharge.

To be able to install the toroidal hose 700, the circumference of which may be adapted to the circumference of piston 420 and hydraulic cylinder 410 and may thus be several hundred m in length, it is expedient for it to be broken down into individual segments 700a, 700b, 700c which can be connected to one another, as shown in FIG. 7b. These may then, as illustrated in FIG. 7c, be introduced into the gap via one of the galleries 470, 480, placed onto a holder 485, and then filled with the fluid 701 via a valve v. During the process of filling with the hydraulic fluid 430, said toroidal hose then floats up and comes to bear against the turnover point 702.

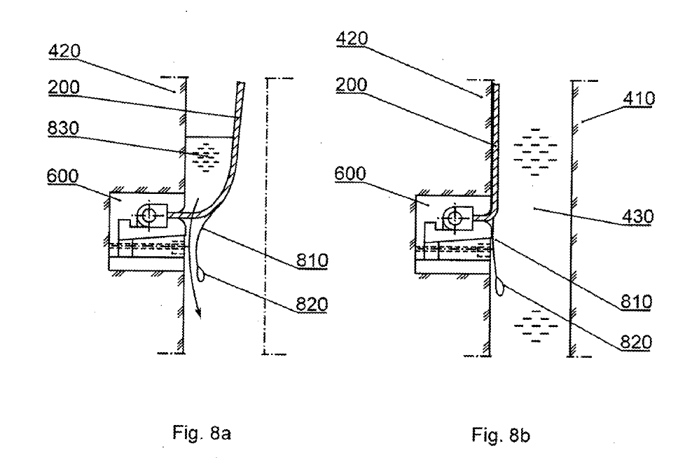

FIG. 8a shows an optional design of an end section of the seal 400 or of the seal membranes 200 before the gap has been fully filled with hydraulic fluid 430. In this design, it is provided that the fluid impermeability of the seal membrane in the region situated at the lower anchor box is realized by means of a seal strip 810 which bears loosely against the bottom side of the support structure of the seal membrane 200 when the latter has been moved into said position, on the end of which seal strip there is provided an eyelet 820. As a consequence of the loose arrangement of the seal strip 810 on the support structure, it is possible in a simple manner, when the potential energy store 100 has been discharged, for seepage water 830 or counterpressure liquid which has passed onto the wrong side of the rolling diaphragm to be drained off by draining the hydraulic fluid 430. By contrast, when hydraulic fluid 430 is situated in the gap, as illustrated in FIG. 8b, the seal strip 810 is pressed against the support structure by the pressure, and thus imparts its sealing action. Here, the eyelet 820 may make it possible, depending on the weight of the seal membrane 200 itself, for the eyelets 820 rather than the clamps 250 to be used for the draining of the seal membrane 200.

Other embodiments of the invention will be apparent to those skilled in the art from a consideration of the specification and/or an attempt to put into practice the invention disclosed herein. It is intended that the specification and examples be considered as exemplary only, with the true scope and spirit of the invention being indicated by the following claims.

1. A seal membrane for producing a seal for a potential energy store, comprising:
a support structure composed of mutually adjacently arranged steel cables or mutually adjacently arranged sections of one or more steel cables, and in the case of which at least parts of the plane in which the steel cables lie or at least parts of a plane running parallel thereto form a fluid-tight face or layer,
wherein each of the one or steel cables are, at the ends of the seal membrane, fastened to a respective one of a plurality of anchor pieces for anchoring the seal membrane or led around the respective one of the anchor pieces, and
wherein at least one elastic element is arranged between at least two of the plurality of anchor pieces.

2. The seal membrane as claimed in claim 1, wherein each of the plurality of anchor pieces and the at least one elastic elements has an opening through which a flexible bracing means is guided, such that the spacing between the at least two anchor pieces can be reduced by compression of the at least one elastic element arranged therebetween and/or can be increased either by relaxation or by expansion of the at least one elastic element arranged therebetween.

3. The seal membrane as claimed in claim 1, wherein the anchor pieces are metal plates with a cable-guiding groove formed therein, the thickness of which, defined by the smallest spacing between two mutually opposite sides, lies between two times and five times the diameter of the steel cables that are used.

4. The seal membrane as claimed in claim 1, wherein the outer contour of the narrow side of the anchor pieces has corners, recesses or projections on the side facing toward the in each case opposite end of the seal membrane.

5. The seal membrane as claimed in claim 1, wherein the fluid-tight face is formed at least inter alia in that the adjacent steel cables or sections of a steel cable are connected to one another at least on one side by means of a fabric, and/or in that the support structure is, at least in sections, at least on one side, either coated with a fluid-tight layer or impregnated with a solidified fluid-tight material.

6. The seal membrane as claimed in claim 5, wherein the seal membrane has, on one longitudinal side thereof, a first connecting section in which fabric and/or fluid-tight layer of one surface are of relatively thin form and, on the other longitudinal side thereof, a second connecting section in which at least the fluid-tight layer and/or the fabric protrudes outward beyond the flexible support structure on the side of said surface.

7. The seal membrane as claimed in claim 1, wherein the seal membrane has an eyelet at at least one of its end sections.

8. The seal membrane as claimed in claim 1,
wherein the seal membrane has, on at least one side, an anti-adhesion layer which counteracts an adhesion of the seal membrane to the corresponding surface of the piston or of the hydraulic cylinder even under high contact pressure.

9. A method for installing a seal with seal membranes on a potential energy store having a hydraulic cylinder in which there is arranged a piston for the storage of energy in the form of potential energy of the piston, wherein the position of the piston relative to the Earth's surface is variable, having a pump by means of which a hydraulic fluid can be pumped via lines into the hydraulic cylinder, such that the piston is raised, and having a generator for converting flow energy of hydraulic fluid which is displaced out of the hydraulic cylinder as the piston moves downward into electricity, wherein the seal is arranged between the hydraulic cylinder and the piston, the method comprising acts of:
providing seal membranes or groups of interconnected seal membranes,
providing a crane on the top side of the piston or on the upper edge of the stroke cylinder,
providing an upper anchor box,
providing a lower anchor box,
suspending the seal membranes or the interconnected groups of seal membranes from the crane,
positioning the seal membranes or the groups of interconnected seal membranes by means of the crane such that the freely hanging end of the seal membranes or of the seal is situated approximately at the level of the upper anchor box,
connecting the seal membranes or the groups of interconnected seal membranes to one another such that a seal is formed,
clamping the freely hanging ends of the seal membranes or of the groups of interconnected seal membranes or of the seal in the upper anchor box,
moving the seal membranes or the groups of interconnected seal membranes or the seal further into the gap between piston and hydraulic cylinder by means of the crane such that that end of the seal membranes or of the groups of interconnected seal membranes or of the seal on which the crane engages is moved approximately to the level of the lower anchor box,
releasing the connection to the crane, and
clamping that end of the seal membranes or of the groups of interconnected seal membranes or of the seal which is situated at the level of the lower anchor box into the lower anchor box.

10. The method as claimed in claim 9,
wherein the provided crane has at least one winch for each seal membrane or for each group of interconnected seal membranes, wherein the winches are movable on a circular arc.

11. The method as claimed in claim 9,
wherein the upper anchor box is provided, and the lower anchor box is provided, by virtue of a groove or recesses being formed into the outer wall of the piston or into the inner wall of the hydraulic cylinder in encircling fashion, wherein a profile is arranged in the groove or recesses, the profile being locally adapted to the outer contour of the narrow side of the anchor pieces, and by virtue of a fixing means for fixing the anchor pieces in the anchor box being provided in the recess or on the profile.

12. The method as claimed in claim 9, wherein the act of suspending includes using a circular-arc-shaped installation traverse to which the seal membrane or the group of interconnected seal membranes are fastened.

13. The method as claimed in claim 9, wherein the act of suspending includes using mechanically openable clamps which engage on anchor pieces of the seal membrane or of the group of interconnected seal membranes.

14. The method as claimed in claim 9, further comprising, before performing the acts of clamping the freely hanging ends and clamping the end of the seal membranes or of the groups of interconnected seal membranes or of the seal, using bracing means arranged in or on the seal membranes to adapt the width of that end of the seal membrane which is to be clamped in each case to the inner radius of the hydraulic cylinder and/or the outer radius of the piston.

15. The method as claimed in claim 9, further comprising, before performing the act of clamping the end of the seal membranes or of the groups of interconnected seal membranes or of the seal, spraying the outer wall of the piston, and/or that side of the seal membrane or of the seal which faces toward said outer wall, with a lubricant.

16. The method as claimed in claim 9, wherein, in the region below the lower anchor box, there is provided a multi-part or single-part toroidal hose, having an inner diameter of the hose which corresponds to the mean width of the gap between outer wall of the piston and inner wall of the hydraulic cylinder, which toroidal hose is filled with a fluid with a density lower than the density of the hydraulic fluid used for the operation of the potential energy store.

17. The method as claimed in claim 9, wherein the radius of the piston is less in a section between the top side of the piston and the upper anchor box than in a remainder of the piston.

18. The method as claimed in claim 9, wherein the act of clamping the freely hanging ends is performed before the act of moving, the act of moving is performed before the act of releasing, and the act of releasing is performed before the act of clamping the end of the seal membranes or of the groups of interconnected seal membranes or of the seal, and
wherein the act of moving includes loading the seal membrane or the group of interconnected seal membranes or the seal with a ballast.
